(19) United States
(12) Patent Application Publication
(10) Pub. No.: US 2014/0299684 A1
(43) Pub. Date: Oct. 9, 2014

(54) System and Method for Separation of Fiber and Plastics in Municipal Solid Waste

(71) Applicants: John Shideler, JR., Georgetown, TX (US); Robert Hallenbeck, Houston, TX (US)

(72) Inventors: John Shideler, JR., Georgetown, TX (US); Robert Hallenbeck, Houston, TX (US)

(21) Appl. No.: 14/212,785

(22) Filed: Mar. 14, 2014

Related U.S. Application Data
(60) Provisional application No. 61/788,236, filed on Mar. 15, 2013.

(51) Int. Cl. B02C 23/14

(52) U.S. Cl. CPC B02C 23/14
USPC 241/19

(57) ABSTRACT

A system and method for separating fiber and plastics in a municipal solid waste stream. The municipal solid waste stream is size reduced in one or more hammer mills. The municipal solid waste stream is pneumatically conveyed to a separator unit whereby the municipal solid waste stream is separated into a medium weight material substantially comprising fibers and a light weight material substantially comprising plastics.

### RELATED APPLICATIONS

This application claims the benefit, and priority benefit, of U.S. Patent Application Ser. No. 61/788,236, filed Mar. 15, 2013, titled “System and Method for Separation of Fiber and Plastics in Municipal Solid Waste.”

### BACKGROUND

1. Field of Invention

The subject matter of this invention generally relates to treatment of municipal sold waste and more particularly relates to separation of municipal solid waste into fiber and plastic components.

2. Description of the Related Art

It is generally known in the art that municipal solid waste can be separated into various components for recycling and/or further processing. Improvements to this technology are desired.

### SUMMARY OF THE INVENTION

In accordance with the illustrative embodiments hereinafter described, a system and method for separating fiber and plastics in pre-engineered municipal solid waste is described.

In an illustrative embodiment, the method includes the steps of: providing a pre-engineered municipal solid waste stream; shredding the pre-engineered municipal solid waste stream; size-reducing the pre-engineered municipal solid waste stream in a primary hammer mill to a size that can pass through a ⅜″ screen; size-reducing the pre-engineered municipal solid waste stream in a secondary hammer mill to a size that can pass through a ¼″ screen; and pneumatically conveying the pre-engineered municipal solid waste to a separator whereby the pre-engineered municipal solid waste is separated into a medium weight material substantially comprising fibers and a light weight material substantially comprising plastics.

In another illustrative embodiment, a method of separating fiber and plastics in a municipal solid waste stream is provided. The municipal solid waste stream is size reduced in a primary hammer mill to a size that can pass through a ⅜″ screen. Then, the municipal solid waste stream is further size-reduced in a secondary hammer mill to a size that can pass through a ¼″ screen. The size-reduced municipal solid waste stream is pneumatically conveyed to a separator unit whereby the municipal solid waste stream is separated into a medium weight material substantially comprising fibers and a light weight material substantially comprising plastics. The medium weight material can comprise 85% fibers. The method can include the additional step of shredding the municipal solid waste stream prior to size-reducing the municipal solid waste stream in the primary hammer mill. A first fan can be disposed adjacent to the primary hammer mill to provide suction and pull the municipal solid waste stream through the primary hammer mill. A second fan can be disposed adjacent to the secondary hammer mill to provide suction and pull the municipal solid waste stream through the secondary hammer mill.

In certain illustrative embodiments, the primary hammer mill and the secondary hammer mill can be disposed in a stacked arrangement. Also, the separator unit can be a cyclone separator, and the municipal solid waste stream can be pneumatically conveyed from the secondary hammer mill to the cyclone separator in a pneumatic conveyer. The method can include the additional step of adjusting the amount of air flow that is supplied to the pneumatic conveyer to control the separation of municipal solid waste in the cyclone separator. In certain illustrative embodiments, an inlet valve can be disposed on the pneumatic conveyer and exposed to outside atmospheric air. The method can include the additional step of opening the inlet valve and introducing outside atmospheric air into the pneumatic conveyer to adjust the amount of air flow that is supplied to the cyclone separator. The inlet valve can be a y-valve. In certain illustrative embodiments, the municipal solid waste can be pre-engineered to remove heavy weight materials prior to being introduced into the primary hammer mill as a pre-engineered municipal solid waste stream.

### BRIEF DESCRIPTION OF THE DRAWINGS

A better understanding of the presently disclosed subject matter can be obtained when the following detailed description is considered in conjunction with the following drawings and figures, wherein:

FIG. 1 is a top plan view of equipment utilized in a system and method for separation of fiber and plastics in municipal solid waste, according to certain illustrative embodiments.

FIG. 2 is a side view of a separator used in a system and method for separation of fiber and plastics in municipal solid waste, according to certain illustrative embodiments.

FIG. 3 is a perspective view of equipment for loading pre-engineered municipal solid waste onto a conveyer in a system and method for separation of fiber and plastics in municipal solid waste, according to certain illustrative embodiments.

FIG. 4 is a perspective view of a hammer mill utilized in a system and method for separation of fiber and plastics in municipal solid waste, according to certain illustrative embodiments.

FIG. 5 is a perspective view of a separator utilized in a system and method for separation of fiber and plastics in municipal solid waste, according to certain illustrative embodiments.

FIG. 6 is a perspective view of a y-valve for providing access to outside air in a system and method for separation of fiber and plastics in municipal solid waste, according to certain illustrative embodiments.

FIGS. 7-11 are perspective views of equipment utilized in a system and method for separation of fiber and plastics in municipal solid waste, according to certain illustrative embodiments.

FIG. 12 is a view of two circle graphs showing a significant increase in fiber content with corresponding reduction in moisture and plastics content in the medium weight materials exiting the separator described herein, according to certain illustrative embodiments.

While certain embodiments will be described in connection with the preferred illustrative embodiments, it will be understood that it is not intended to limit the invention to those embodiments. On the contrary, it is intended to cover all alternatives, modifications, and equivalents, as may be included within the spirit and scope of the invention as defined by the appended claims.

### DETAILED DESCRIPTION

The presently disclosed subject matter relates generally to a system and method for separating pre-engineered municipal solid waste into fiber and plastic components. After separation, the fiber and plastic components can be either recycled or converted to other high-value products using various waste conversion technologies. The subject matter is described more fully hereinafter with reference to the accompanying drawings in which illustrative embodiments of the system and method are shown. The system and method may, however, be embodied in many different forms and should not be construed as limited to the embodiments set forth herein; rather, these embodiments are provided so that this disclosure will be thorough and complete, and will fully convey the scope of the system and method to those skilled in the art.

As used herein, the term “municipal solid waste” or “MSW” means waste that includes, but is not limited to, one or more of the following materials: heavy weight materials (i.e., aggregates, glass, textiles, rubber, etc. . . . ), medium weight materials (i.e., fibers and rigid plastics), light weight materials (i.e., foam plastics and film plastics), PVC plastics, ferrous and non-ferrous metals, inert residues, food waste, and very heavy and/or bulky materials. As used herein, the term “fibers” includes paper and/or cardboard and like materials, including but not limited to organic solids such as cellulose, hemicellulose, lignin, ash and other like unclassified organics, the term “clean plastics” includes rigid plastics, foam plastics and film plastics and like materials, and the term “undesirable plastics” means plastics that are known to contain high levels of chlorine (i.e., PVC plastics). As used herein, the term “pre-engineered municipal solid waste” or “PMSW” means municipal solid waste that has been previously size reduced and/or partially decontaminated such that all, substantially all, or some portion of the heavy weight materials, undesirable plastics, ferrous and non-ferrous metals, inert residues and very heavy and/or bulky materials have been removed, such that the municipal solid waste primarily comprises a mix of medium weight materials and light weight materials. The pre-engineered municipal solid waste may be a waste stream that was originally intended for densification to form pelletized fuel before being directed to the presently disclosed system and method.

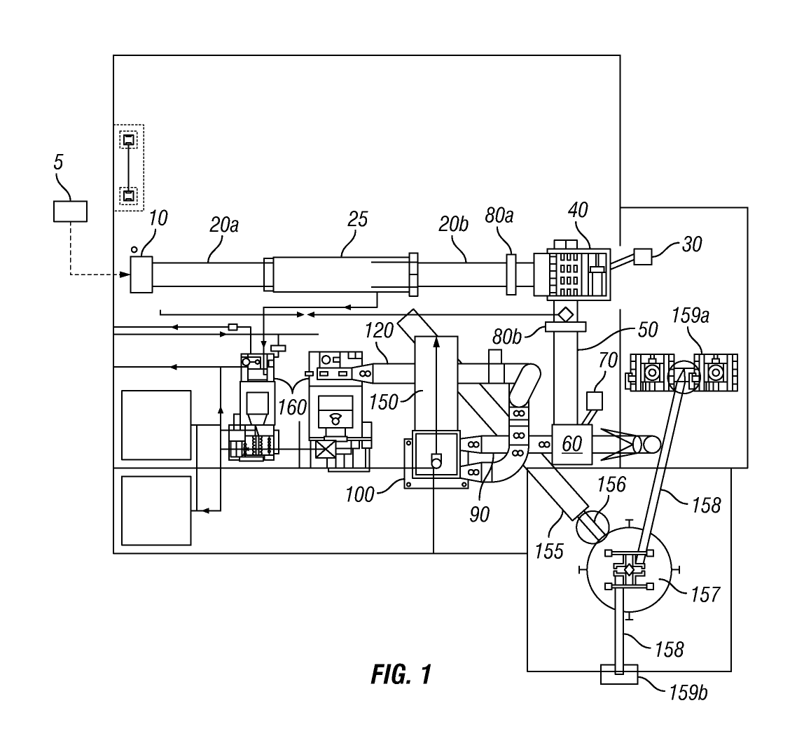

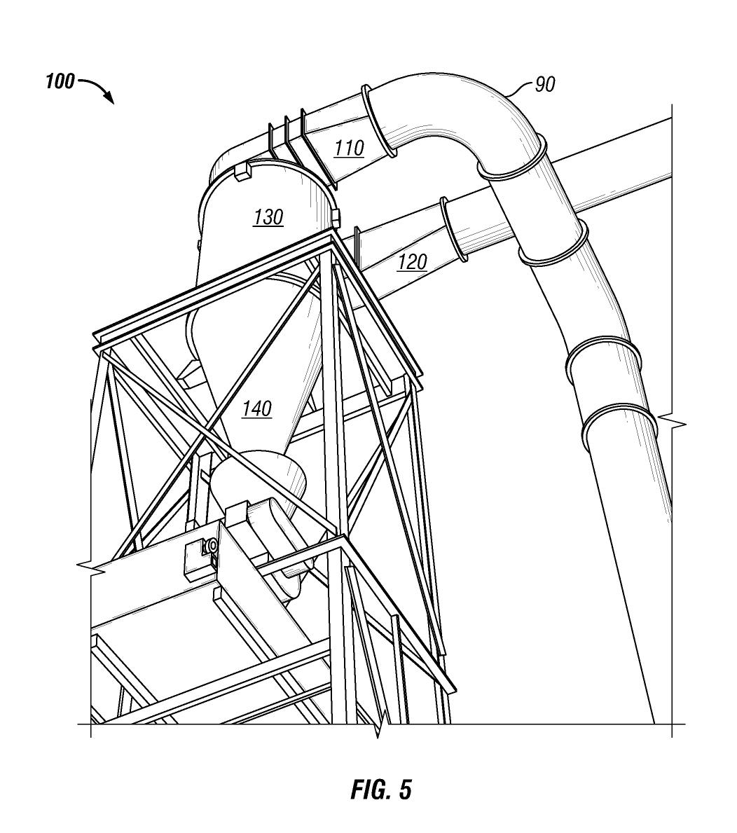

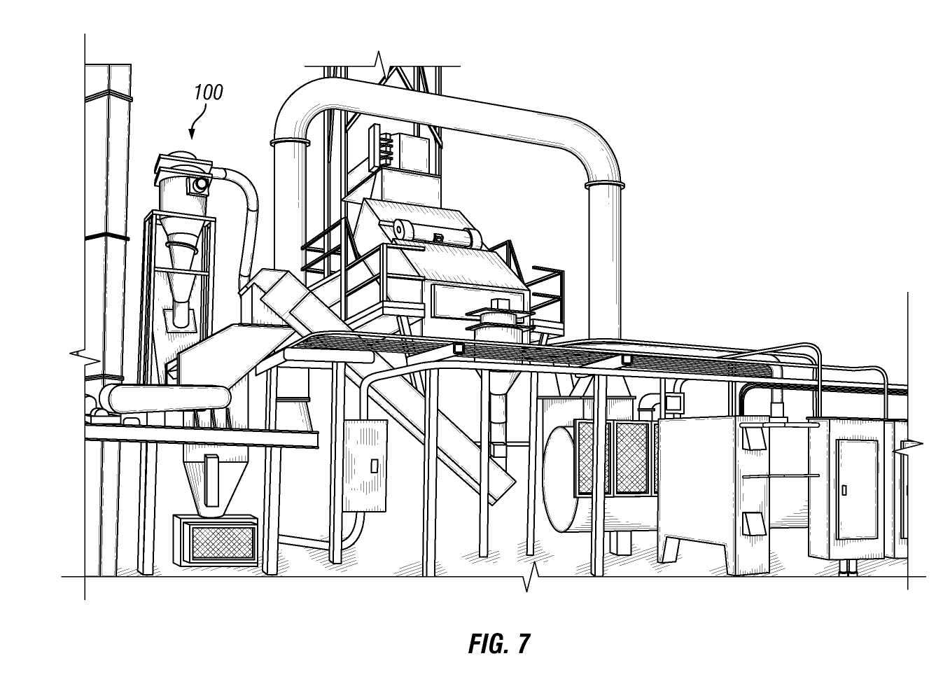

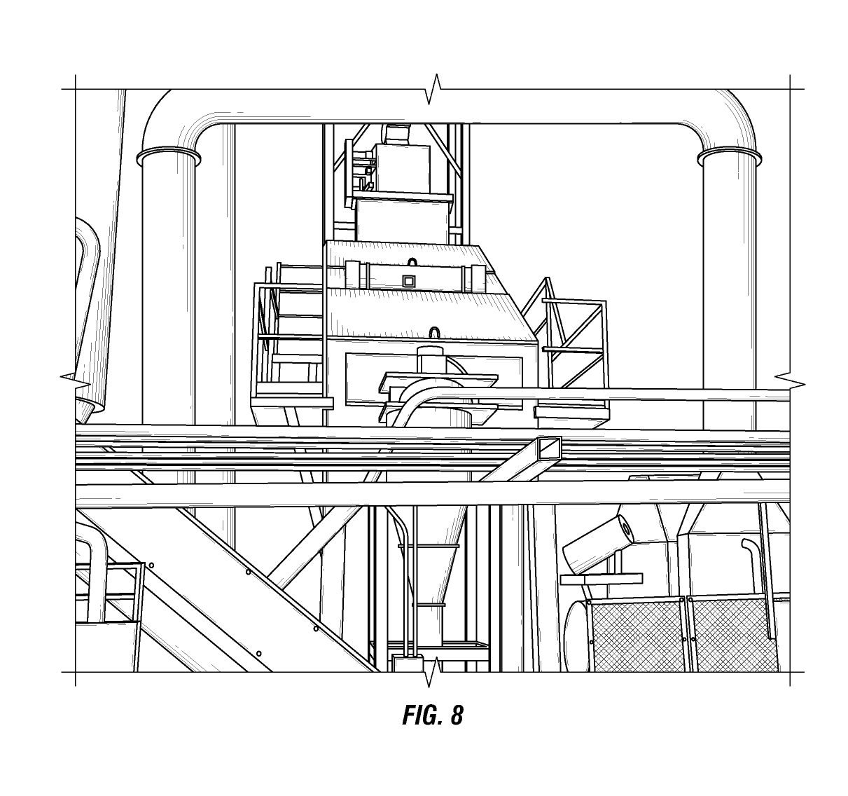

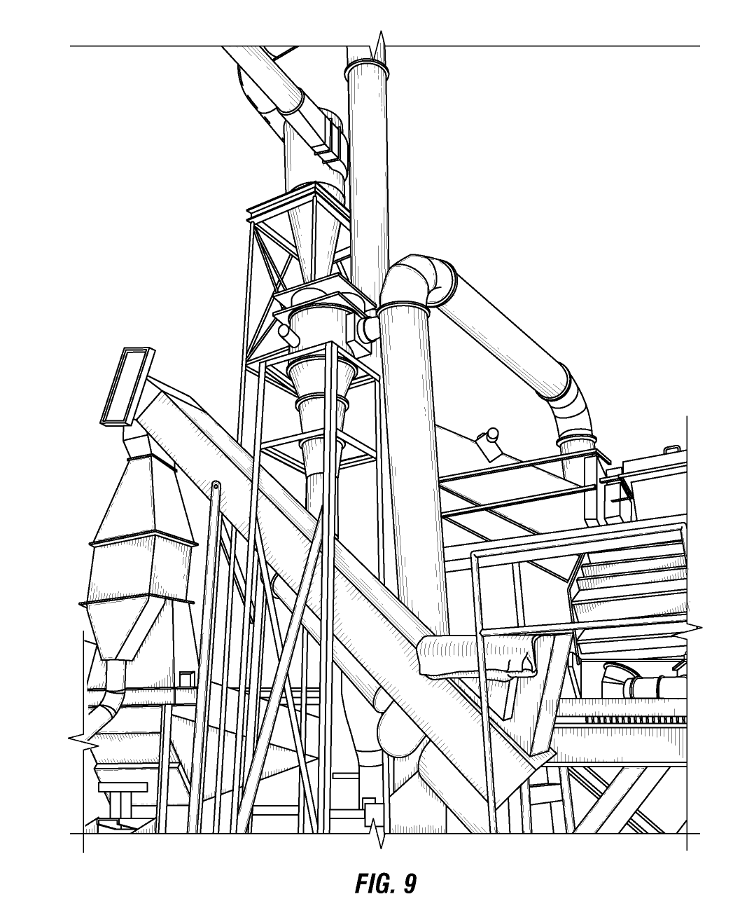

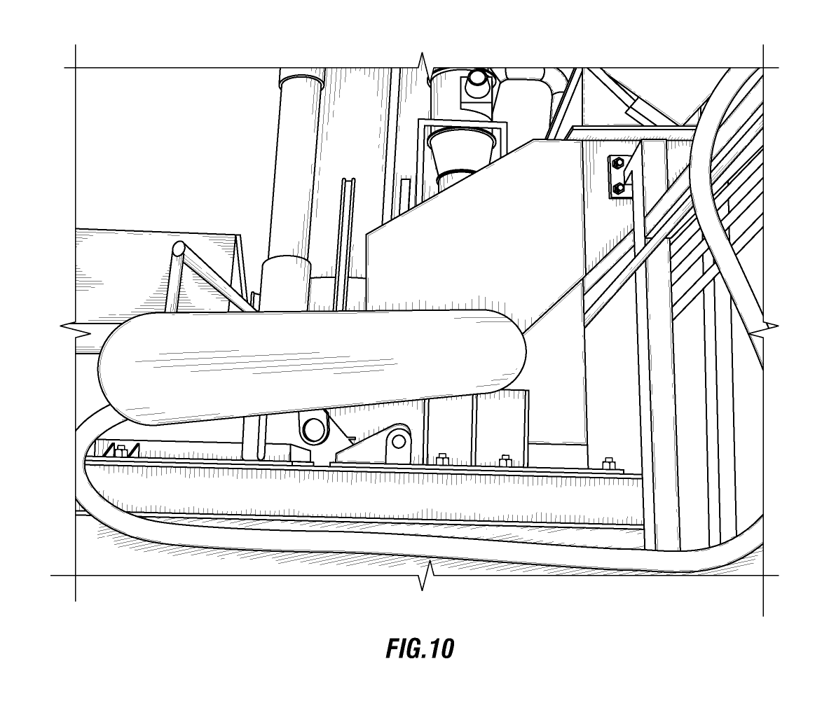

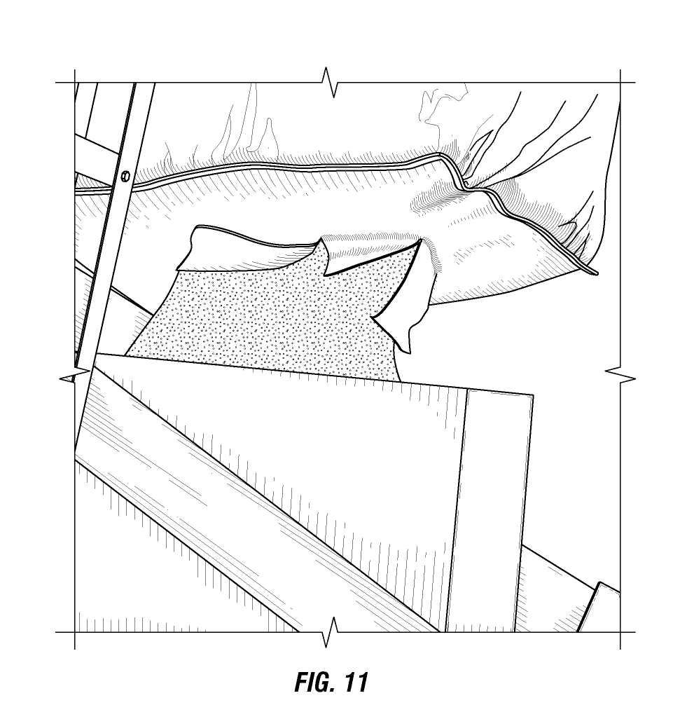

Referring now to FIGS. 1-11, various illustrative embodiments of a system and method for separating pre-engineered municipal solid waste into fiber and plastic components are provided. Prior to undergoing the various steps described herein, the pre-engineered municipal solid waste can be pre-shredded to a 5″ minus size, in certain illustrative embodiments. In other illustrative embodiments, the pre-engineered municipal solid waste can be pre-shredded to a 2″ minus size. In still other illustrative embodiments, the pre-engineered municipal solid waste can be pre-shredded to between 2″ and ¼″, whereby further size reduction would not be required in the hammermills of the presently disclosed system and method. In still other illustrative embodiments, the pre-engineered municipal solid waste can be pre-shredded to a 12″ minus size, when, for example, the separation of larger sized particles would be preferred and/or beneficial. In each of the above described illustrative embodiments, removal of metals to prevent equipment damage and to capture recycling value would be preferred.

In certain illustrative embodiments, the shredded or unshredded pre-engineered municipal solid waste can be collected and deposited in a hopper 10. For example, hopper 10 can be of carbon steel construction and may be loaded by any suitable feed, loading, or supply device as would be understood by one of skill in the art. For example, the pre-engineered municipal solid waste can be supplied to hopper 10 from a large storage sack using a forklift, or by a front end loader or similar device.

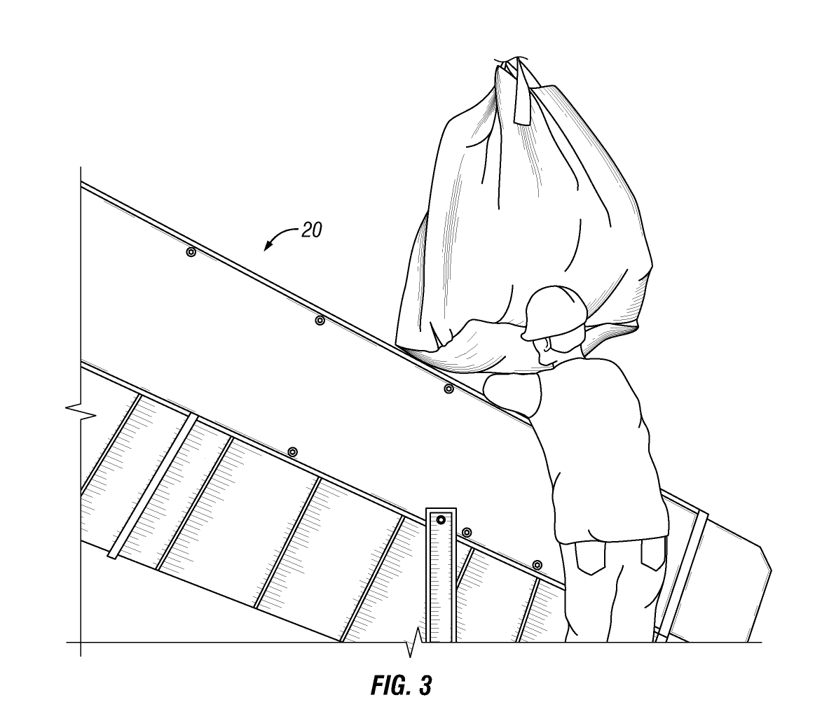

In certain illustrative embodiments, the contents of hopper 10 can be emptied onto a first conveyer 20. First conveyer 20 can be, for example, an incline cleated conveyer and may be driven by any suitable motor. The pre-engineered municipal solid waste can also be deposited directly onto first conveyer 20, without the need for hopper 10, as shown in FIG. 3.

In certain illustrative embodiments, first conveyer 20 can pass through, or connect to, a cooling drum unit 25 that can cool the pre-engineered municipal solid waste, as needed. First conveyer 20 can comprise a single conveyer 20, or a plurality of conveyers 20a and 20b, depending upon the capability of cooling drum unit 25 to transport and/or merely cool the pre-engineered municipal solid waste. In other illustrative embodiments, there is no need for any cooling of the pre-engineered municipal solid waste before it undergoes subsequent process steps, and thus drum unit 25 is not required in the described system and method.

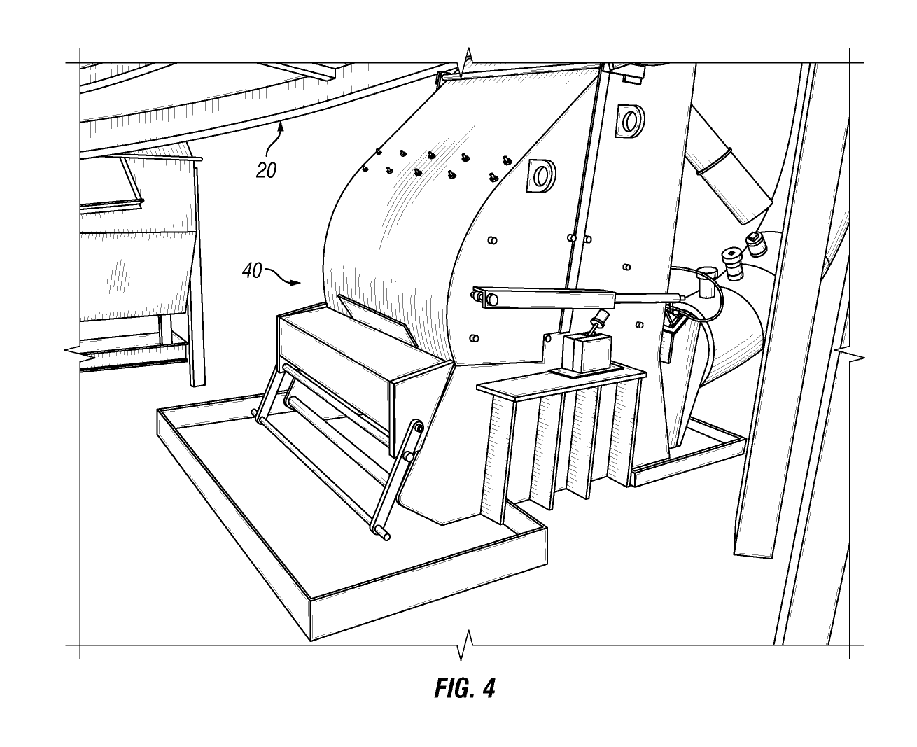

In certain illustrative embodiments, the pre-engineered municipal solid waste can undergo a series of size reductions before undergoing separation. The extent of size reduction that is performed will depend upon the desired application for the fiber and plastic components produced as end products. In a preferred embodiment, first conveyer 20 can deliver the pre-engineered municipal solid waste to a primary hammer mill 40, as illustrated in FIG. 4. In primary hammer mill 40, a rotating set of hammers can pulverize and/or reduce the pre-engineered municipal solid waste to a desired size. Primary hammer mill 40 can accommodate at least thirty wet inbound tons per hour of materials, in certain illustrative embodiments. Also, a first induced draft suction fan 30 can be disposed adjacent to primary hammer mill 40 to pull the pre-engineered municipal solid waste through primary hammer mill 40. In certain illustrative embodiments, primary hammer mill 40 can reduce the pre-engineered municipal solid waste into smaller sized particles. For example, in certain embodiments primary hammer mill 40 can produce particles that would be able to pass through a ⅜″ screen.

In certain illustrative embodiments, the smaller sized particles of pre-engineered municipal solid waste can exit primary hammer mill 40 and be disposed onto a second conveyer 50. Second conveyer 50 may be driven by any suitable motor. Second conveyer 50 can deliver the smaller sized particles of pre-engineered municipal solid waste to a secondary hammer mill 60. Secondary hammer mill 60 can preferably accommodate at least twelve wet inbound tons per hour of materials, in certain illustrative embodiments. A second induced draft suction fan 70 can be disposed adjacent to secondary hammer mill 60 to pull the pre-engineered municipal solid waste through secondary hammer mill 60.

In certain illustrative embodiments, secondary hammer mill 60 can reduce the pre-engineered municipal solid waste into smaller sized particles than primary hammer mill 40. For example, secondary hammer mill 60 can produce smaller sized particles that would be able to pass through a ¼″ screen. A representative example of primary hammer mill 40 and secondary hammer mill 60 would be those sold by Schutte Buffalo Hammermill, LLC of Buffalo, N.Y. The first draft induced suction fan 30 and second draft induced suction fan 70 provide the additional advantage of removing moisture from the particles due to the increased surface area that was exposed after processing in primary hammer mill 40 and secondary hammer mill 60.

In certain illustrative embodiments, second conveyer 50 is not required, and instead, primary hammer mill 40 can be stacked or otherwise disposed directly on top of secondary hammer mill 60. This particular embodiment would help to alleviate certain material losses that may be experienced during operation due to, for example, materials being swept from second conveyer 50 by high winds. This particular embodiment would also result in reduced moisture since primary hammer mill 40 would receive increased airflow when stacked as described herein.

Throughout the presently disclosed system and method, magnets can be positioned at various extraction points to extract ferrous metals from the pre-engineered municipal solid waste and maximize ferrous metal recovery. For example, first magnet 80a can be positioned adjacent to first conveyer 20 and second magnet 80b can be positioned adjacent to second conveyer 50, in certain illustrative embodiments. All ferrous metals extracted from the municipal solid waste are preferably recycled.

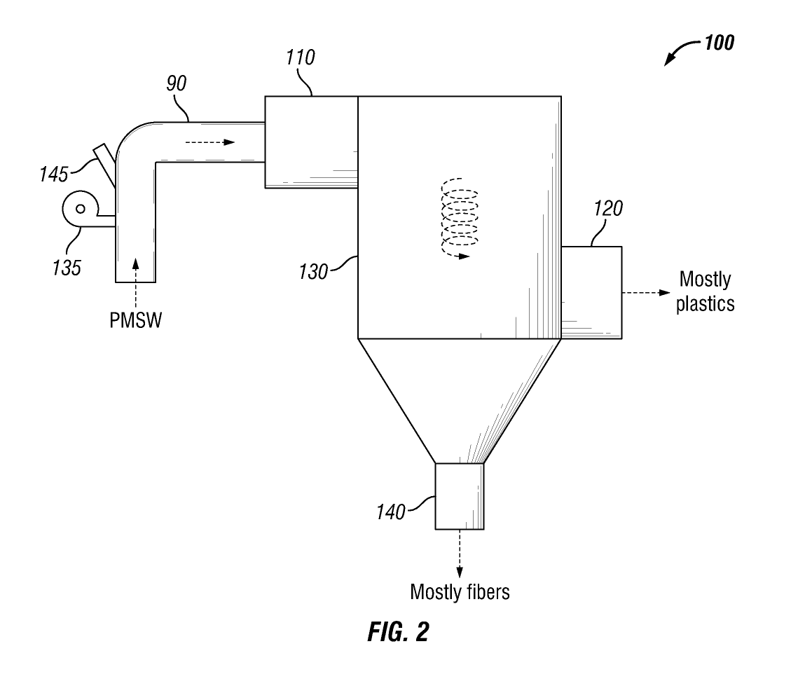

In certain illustrative embodiments, the smaller sized particles of pre-engineered municipal solid waste can exit secondary hammer mill 60 via a pneumatic conveyer 90. Pneumatic conveyer 90 can transport the smaller sized particles conveniently by means of a stream of high velocity air through the conveyer piping. In certain illustrative embodiments, pneumatic conveyer 90 can deliver the smaller sized particles of pre-engineered municipal solid waste from secondary hammer mill 60 to a separator 100, as shown in FIGS. 2 & 5. Separator 100 can preferably separate the pre-engineered municipal solid waste into medium weight materials and light weight materials, in certain illustrative embodiments.

In a preferred embodiment, separator 100 is a cyclone separator capable of separating fibers from plastics. The cyclone separator can be a multi-cyclone separator, if desired, whereby the first cyclone would remove paper/cardboard and the second cyclone would remove plastic. Separator 100 can also be a ballistic separator, in other embodiments. A ballistic separator works on the principle that the flat, flexible cardboard, paper and plastic film will carry over the top of the paddles to the front of the separator, while rigid and three dimensional plastic and metal containers will roll down the paddles and exit at the back of the separator. The third fraction sorted by the ballistic separator will fall through the sieve mesh of the paddles. This material is nominally a minus 2″ sizing, to ensure minimal loss of recyclables. Representative manufacturers include General Kinematics, Stadler and MetalTech. In general, separator 100 should be sized appropriately based upon the size of the particles of pre-engineered municipal solid waste that are being separated.

As illustrated in FIG. 2, separator 100 can comprise an upper inlet 110, an upper outlet 120, a cylindrical zone 130 and a lower outlet 140. The pre-engineered municipal solid waste can enter separator 100 via upper inlet 110. In certain illustrative embodiments, the pre-engineered municipal solid waste is pulled or forced through pneumatic conveyer 90 into upper inlet 110 by a high powered air stream and then directed into cylindrical zone 130. The high powered air steam can be supplied by one or more motor-controlled fans 135, and the speed of the air stream can be controlled by adjusting the output of said fans 135. Preferably, the high powered air stream will carry the pre-engineered municipal solid waste through upper inlet 110, and then the air stream will lose velocity as the materials circulate within cylindrical zone 130. The medium weight materials from the pre-engineered municipal solid waste (primarily fibers, with some plastics) will fall out to lower outlet 140, while the light weight materials in the pre-engineered municipal solid waste (primarily plastics, with some fibers) will be directed to upper outlet 120.

In certain illustrative embodiments, a screener 150 can be disposed at or near lower outlet 140. Screener 150 can be utilized to further separate any remaining plastics from the primarily fiber materials exiting from lower outlet 140. The materials collected in screener 150 can be removed, while materials passing through screener 150 can fall to a tertiary conveyer 155. In certain illustrative embodiments, tertiary conveyer 155 can deliver the materials to a bucket elevator 156 which can drop them into a silo 157. Silo 157 directs the materials onto one or more loading conveyers 158 which deliver the materials to a bag filling station 159a and/or truck loading station 159b. In other illustrative embodiments, screener 150 may not be needed, and can be removed from the described system and method.

In certain illustrative embodiments, one or more wet scrubbers 160 can be disposed at or near upper outlet 120. Wet scrubbers 160 can be utilized to further separate any remaining fibers from the primarily plastic materials exiting from upper outlet 120, to the extent such further separation is needed or desired. A bag house 170 (not shown) can also be utilized in place of, or together with, wet scrubber 160, to allow for removal of additional material that is currently exhausted through wet scrubber 160 as well as recover the plastic rich fraction.

In certain illustrative embodiments, the effectiveness of separator 100 depends, at least in part, on the speed of the air flow passing through it: the higher the speed of the air flow, the greater the inertia possessed by the pre-engineered municipal solid waste particles that are being thrown against the interior walls of cylindrical zone 130, thus causing greater separation. In certain illustrative embodiments, the speed of the air flow can be controlled and/or adjusted by, for example, opening and closing one or more dampers 160 (not shown) disposed on the separator 100, although this method may result in stress to, and/or stalling of, motor-controlled fans 135. In other illustrative embodiments, the speed of the air flow can be controlled by, for example, adjusting the speed of motor-controlled fans 135 that supply the high powered air steam, although this would require the use of a variable frequency drive (“VFD”) which may be prohibitively expensive.

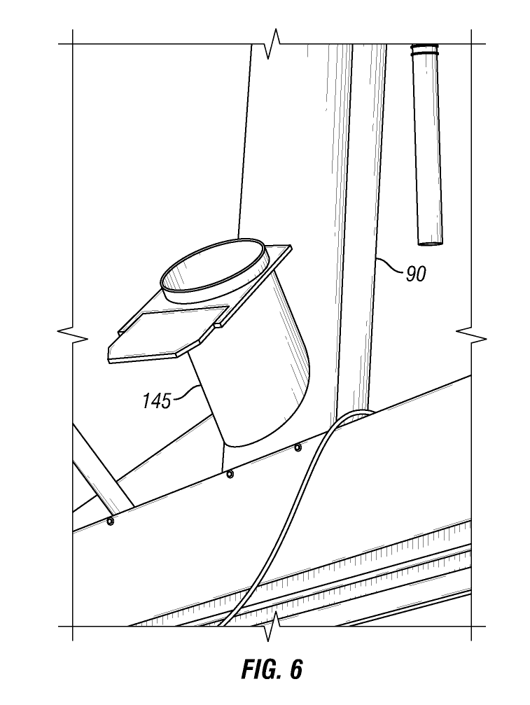

In a preferred illustrative embodiment, a y-valve 145 can be disposed on pneumatic conveyer 90, as shown in FIGS. 2 and 6. Y-valve 145 exposes the air flow within pneumatic conveyer 90 to the outside atmosphere, thus allowing an operator to further adjust the amount of air flow that is supplied to separator 100. In general, if there is not enough air flow through separator 100, the pre-engineered municipal solid waste can build up in the primary hammer mill 40 and/or secondary hammer mill 60 and cause them to stall out. Alternatively, if there is too much air flow through separator 100, the pre-engineered municipal solid waste will not separate effectively in separator 100, and the fibers and plastics will all pass through to upper outlet 120 without adequate separation. Y-valve 145 allows for improved control of air flow without stalling of motor-controlled fans 135 and is less expensive than implementing a VFD.

Experimental results have indicated that, at a fan speed of about 5000 CFM, efficient separation occurs whereby all, or substantially all, of the medium weight materials (mainly fibers) fall out of separator 100 to lower outlet 140 and all, or substantially all, of the light weight materials (mainly plastics) are directed to upper outlet 120. As used herein, the term “CFM” means cubic feet per minute, which is calculated by the following formula: air speed (feet per minute)×area (square feet). In these experimental results, separator 100 appeared to have removed the majority of the plastics from the medium weight materials dropping out at lower outlet 140 such that little or no screening occurred at screener 150. That is, most of the materials collected on the screen of screener 150 were fibers, with very little plastic material passing through. Further, the medium weight materials collected onto the screen of screener 150 contained very little moisture, which was likely a result of drying in the duct work of pneumatic conveyer 90 connecting secondary hammer mill 60 to separator 100 and in separator 100 itself.

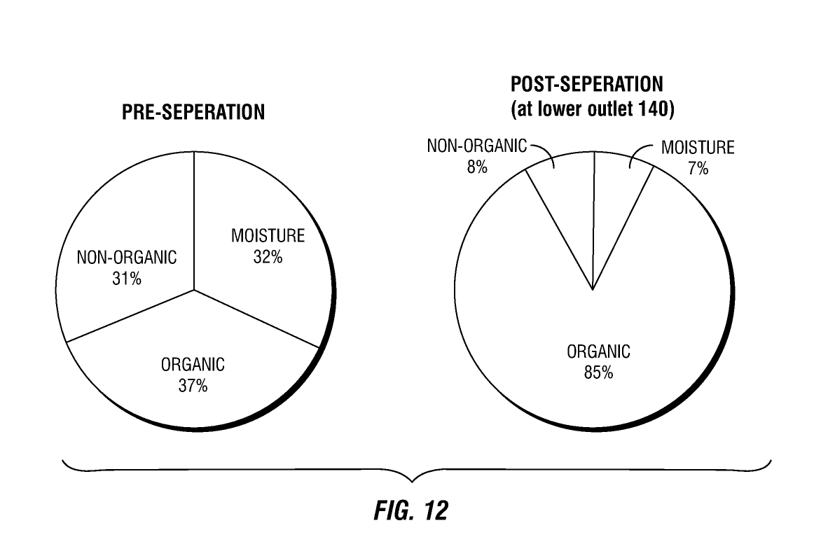

Approximately five pounds of the medium weight materials exiting lower outlet 140 and collected onto the screen of screener 150 were sent off for compositional analysis. While a process mass balance was not performed, it is believed that there was a mix, by weight, of approximately ⅓ fibers (paper/cardboard), ⅓ plastics and ⅓ moisture in the pre-engineered municipal solid waste entering separator 100, based on previous compositional studies of post-shred material. The results of the compositional analysis show a significant increase in fiber content with corresponding reduction in moisture and plastics content in the medium weight materials exiting lower outlet 140, as illustrated in FIG. 12, in which the term “organic” means fibers and the term “non-organic” means plastics

Additional evidence of the significant increase in fiber content with corresponding reduction in moisture and plastics content in the medium weight materials exiting lower outlet 140, is illustrated in Table 1 shown below, with further delineation of the specific components of the fiber product.

TABLE 1
Comparison - Pre/Post Separation

| | BEFORE | | | AFTER | | |
|---|---|---|---|---|---|---|
| | | | Total | | | Total |
| | Total | Total | Organic | Total | Total | Organic |
| Component | % | Solids % | Solids | % | Solids % | Solids % |
| Moisture | 32% | — | — | 7% | — | — |
| Solids | 68% | — | — | 93% | — | — |
| Organic | 37% | 55% | — | 85% | 91% | — |
| Solids | | | | | | |
| Non-Organic | 31% | 45% | — | 8% | 9% | — |
| Solids | | | | | | |
| Cellulose | 16% | 23% | 42% | 35% | 37% | 41% |
| Hemi- | 6% | 8% | 15% | 15% | 16% | 18% |
| cellulose | | | | | | |
| Lignin | 9% | 14% | 25% | 17% | 18% | 20% |
| Ash | 5% | 7% | 13% | 13% | 14% | 15% |
| Unclassified | 2% | 3% | 6% | 5% | 6% | 6% |
| Organics | | | | | | |

In certain illustrative embodiments, the pre-engineered municipal solid waste can be treated in a pulper 5, such as a drum pulper or hydro pulper 5, at a very preliminary stage. For example, pulper 5 can be located at or near the trommel screens utilized for pre-screening of the municipal solid waste. Pulper 5 can mechanically and chemically process the fibers to reduce them to pulp. The pulp would then be removed from the pre-engineered municipal solid waste and processed separately. In certain illustrative embodiments, a continuous, wet mill, rotary pulverizer can be utilized with pulper 5 to process the pre-engineered municipal solid waste. Pulper 5 can pulverize, agglomerate and sanitize the food, card and paper waste to a homogenous organic fiber which can be discharged through the trommel screen. This would leave only metal and plastics remaining, which could easily be magnetically-separated. Depending on the water recovery system, this process may generate a liquid waste. Additional drying can be accomplished with a filter press, which would be an inexpensive alternative to conventional dryers.

In a preferred embodiment, the above described system can remove about 50-60% of the incoming municipal solid waste. The remaining 40-50% of clean plastic, along with other materials such as wood and metal, could be easily separated with additional equipment. The pulp would be processed to the end product specifications desired by the customer. For example, if the material is required to be dried, it could be sent through a filter press to obtain the desired moisture level. In other illustrative embodiments, the reduction of the moisture level may not be required. The trommel screen fines could go through a similar process which would allow for separation of organics into cellulose/hemicellulose/sugar, lignin, fats, proteins and miscellaneous organic extractive compounds, in certain illustrative embodiments.

To summarize a particular non-limiting embodiment, a method of separating fiber and plastics in pre-engineered municipal solid waste is provided, wherein the method includes the steps of: providing a pre-engineered municipal solid waste stream; shredding the pre-engineered municipal solid waste stream; size-reducing the pre-engineered municipal solid waste stream in a primary hammer mill to a size that can pass through a ⅜″ screen; size-reducing the pre-engineered municipal solid waste stream in a secondary hammer mill to a size that can pass through a ¼″ screen; and pneumatically conveying the pre-engineered municipal solid waste to a separator whereby the pre-engineered municipal solid waste is separated into a medium weight material substantially comprising fibers and a light weight material substantially comprising plastics.

The final products of the presently disclosed system and method can be utilized in a variety of ways. For example, the fiber and/or plastic materials can be recycled via traditional means or used to produce a feed stock for a pelletizing plant for producing fuel products. Alternatively, the fiber and/or plastic materials can also be utilized in a variety of waste conversion technologies such as gasification, pyrolysis (for syn-crude conversion), acid hydrolysis and supercritical hydrolysis. At a minimum, reducing contaminant load early in the system and method reduces the amount of inert materials, which reduces equipment size and overall capital expenditures. In many circumstances, high volumes of contaminants will foul the process or product. Additional screening, bagging and loading systems (not shown) may be provided to effectively collect and transport the fiber and/or plastic materials, depending upon the intended use for the final product.

In certain illustrative embodiments, one or more additional features can be included with the presently disclosed system and method. For example, sorting platforms and stations can be utilized. These platforms and stations can be designed for manual removal of recycled waste. Waste can be fed to a sorting platform on a conveyor picking belt. Simple conveyor belts can include steel belts, roller chain belts, PVC-style belts, flat belt sliders, and troughers. As the waste material is fed onto the conveyor belt, vibratory motion can be used to spread the waste out onto the belt for ease of observation. Manual picking stations can line one or both sides of the moving conveyor belt. Each picking station can be devoted to one type of recyclable material with appropriately sized collection bins.

Specialized fiber sorting systems can be utilized for each major type of recycled paper waste: corrugated cardboard, newsprint, and stiff containers. Screeners can be used to remove valuable recyclables at the end of the conveyor system. This greatly reduces the need for labor-intensive hand removal out of the wastestream, though a few quality-control pickers are typically needed to inspect the material and remove miscellaneous contaminants. Corrugated cardboard separators utilize a relatively simple screening operation. The larger corrugated containers are conveyed across the screen, while office paper, newsprint, and smaller contaminants fall through the screening surface. Bulk sorting devices can further clarify the wastestream by removing other paper fiber and mixed containers. Additional refinement of the wastestream can be achieved by using a high grader system designed to remove chipboard, junk mail, and other small contaminants from incoming residential fiber material. A typical fiber sorter can measure approximately 22.5×14×11 ft. high and weigh approximately 9 tons. Power requirements are 10-15 hp driven by 208-, 230-, 380-, 415-, or 575-volt three-phase power. Typical production capacity is approximately 15 tph.

Gypsum board recycling systems can also be utilized. These are specialized sorters utilized to remove drywall from construction and demolition (C&D) debris and break it down to remove its gypsum core. Scrap gypsum board is loaded in the in-feed hopper and carried through the in-feed metering system, which delivers an even flow into the gypsum separator component. A flexible impact system removes the paper facing from the gypsum board and breaks down the gypsum core into valuable-size materials. Second-stage removal of ferrous materials from the gypsum can be accomplished with a trommel and magnetic separator combination. The trammel can separate fine gypsum from coarse gypsum.

Disc-type sorters utilize rotating discs to impart a wavelike motion into the material stream. The wave motion raises larger objects to the top of the incoming waste mass, causing smaller objects and particles to settle to the bottom. Disc sorting usually is combined with screening to allow separation of smaller objects and debris and/or decks to separate larger objects. Disc-type sorters can jam if overloaded with debris and waste containing many small objects. Most come with a variable-speed drive option, however, that allows the operator to adapt to different types of corrugated cardboard and paper. This ensures the even flow of material over the screening sections. A typical disc-type sorter measures approximately 30×8×10 ft. high and weighs approximately 15 tons. Power requirements are 5-10 hp driven by 208-, 230-, 380-, 415-, or 575-volt three-phase power. Typical production capacity is approximately 30 tph.

Magnetic belt separators can be utilized to directly remove ferrous materials from the waste stream. They can be either floor-mounted or suspended by support beams over a moving conveyor belt. Magnetic pulls of 15 in. or greater can be achieved. The magnetic belt separator moves like a conveyor belt, carrying the materials to stripper magnet for controlled discharge. A stainless steel section on existing conveyor installations can be utilized for maximum magnet effectiveness. The power source for the system can be electrical: 208/230V single phase or 208/230/460V three phase, housed in a NEMA 4 (watertight) enclosure.

Eddy-current separators can be used to separate conductive but nonferrous metals from lightweight commingled waste. This is usually performed near the end of a commingled separation-system process. For example, eddy-current separators can be useful for separating aluminum from plastic mix. The separators work through the principle of high-frequency oscillatory magnetic fields, which induce an electric current in the conductive object. The oscillating fields can be adjusted to optimize separation. This electric current generates a magnetic field, which causes the object to be repelled away from the primary magnetic field. Conductive particles are fed either directly into the separator's rotating drum or onto a belt enveloping the drum. Aluminum, brass, copper, magnesium, and zinc can be separated from nonmetallic materials such as glass, paper, plastic, rubber, and debris. They are also used to separate computer and electronic scrap.

Trommel screens can also be utilized. Trommel screens are rotating drums that use a combination of rotation and screening to clarify MSW, construction debris, turnings, demolition lumber, paper, ferrous, and nonferrous scrap. Diameters can range from approximately 2 to 16 ft., while lengths run from approximately 8 to 80 ft. Trommels are typically driven by a trunnion wheel or a double-strand roller chain. The tumbling motion created by the rotating drum shakes loose smaller particles that exit through the screen, leaving behind the materials to be recycled.

Screening units can combine vibratory action with screen separation. Municipal solid waste, C&D debris, green waste, and wood products can be fed onto the screen, and the vibratory action causes the smaller particles to fall through and separate from the larger, recoverable materials. Screens of assorted opening sizes can be stacked into double and triple decks which allows for multiple separation of various-size materials. Separated material can be deposited onto conveyor belts and stackers for delivery to containers or stockpiles.

Portable screening units can be used for separation of excavation spoil, clearing and grubbing debris, and C&D debris. The object is to remove dirt, sand, rock, and other small, abrasive contaminants prior to further processing downstream. This removal significantly reduces subsequent wear and tear on the machinery.

Debris roll screens are derived from disc-screen designs. Disc screens were originally used in the wood-products and pulp and paper industries but were found to be inadequate for bulk waste recycling because of excessive jamming. A debris roll screen utilizes a shape and configuration that allows it to process MSW, green waste, biomass debris, C&D debris, wood chips, compost, and aluminum. The debris roll screen uses oval-shape rollers to create a wave action in the incoming waste. This agitation releases smaller materials through screen openings and operates without vibration or blinding. Debris roll screens also come in portable units, which are used primarily to prescreen green waste and C&D debris by removing dirt, rock, sand, and other abrasive materials prior to being processed by size-reduction machinery. Debris rolling screens also can be designed to remove objects in the 3- to 4-in.-minus range, allowing for the removal of organics, printer cartridges, and aluminum cans.

Finger screen vibratory classifiers are an alternative to rotary trommels or disc-type screening devices. Solid waste material cascades over a series of slotted finger elements that successfully classify the incoming waste stream. The finger screen vibratory design avoids the catching or hang-ups that can occur in conventionally perforated wire-mesh screening equipment. The classifiers can be used for C&D debris, commingled waste, paper classification, and removal of metal or glass from mass-burn bottom ash. The classifiers also have no rotating shafts that require periodic production stops to remove wound material.

Destoner dry classifiers utilize a combination of vibratory action and high-velocity air streams. Destoners fluidize and stratify material according to the differences in their terminal velocities, and can handle high volumes of commingled materials, shredded MSW, auto scrap “fluff,” biomass fuel, and refuse-derived fuel. Heavy items such as glass, metals, stones, and dirt can be efficiently removed by this jam-proof unit, which has no moving parts to wear or maintain.

Air clarifiers allow for automatic and continuous recovery of uniform-quality, thin plastic film and mixed wastepaper, which typically is removed manually. Low-velocity airflows can be used to clarify the waste materials and augment standard high-velocity air-knife procedures. Relatively high-velocity air generated by a primary suction fan with sufficient air volume is used for general conveying purposes of the initial mixed fraction taken off the host's final residue conveyor. A selected light mixed faction is first lifted off the final residue conveyor by an air pickup unit. Air velocities within the pickup unit are controlled at a lower velocity to allow selective pickup. Materials not selected for pickup remain on the residue conveyor belt. Once in the separation chamber, the material is subjected to two separate pressure drops. Items heavier or denser than loose paper or plastic film drop out, allowing for recovery of a 40% plastic-film fraction. As mixed paper and plastic film account for about 60% of the volume and 50% of the weight of a solid waste stream, the addition of an air clarifier can greatly improve the performance of a MRF. Systems can be designed to process 10-50 tph of solid waste.

Commingled separation systems can combine several types of sorters to achieve maximum separation of various recyclables. This kind of system has the inherent advantage of simplifying recycling at the consumer level. A typical system delivers four materials: pulverized glass, ferrous metal, aluminum, and plastics. No labor is required to separate these materials, though some presorting labor might be needed at the start of the system to remove the large plastic bags, trash, or paper in the commingled mix. At the end of the system, one or two sorters may be used to separate the polyethylene terephthalate (PET) from the natural and colored high-density polyethylene (HDPE) plastics. At the start, the commingled material is loaded into the system for presorting. The commingled containers pass under a magnetic belt separator, where ferrous metals are removed. It then passes on to a breaker, where frangible material (glass) is reduced in size. Next, the material is conveyed to a trommel separator, where the glass is removed from the aluminum and plastic. Plastic is sized by a screen to assist in the separation of HDPE and PET, and an eddy-current separator can remove the aluminum from the plastic mix.

Cyclones and hammer mills can separate the plastic from the paper/cardboard fiber. Also, electrostatic separation on high voltage electrostatic fields can be used to separate nonconductors of electricity like glass, plastic, paper, from conductors such as metals. It is also possible to separate non conductors from each other based on differences of their electric permittivity or ability to retain electric charge. In this same manner, paper can be separated from plastic or plastics from each other.

Float-sinking is a process where, working on the principal of relative densities, materials could be separated based on density using a set of solutions with modified specific gravities to separate different materials. The results would be a series of “cuts” based on density, akin to an oil refinery defining cuts based on boiling point. The process would require separating particles when larger to prevent particles of different densities from sticking to each other and preventing an effective separation.

In the drawings and specification, there have been disclosed and described typical illustrative embodiments, and although specific terms are employed, the terms are used in a descriptive sense only and not for purposes of limitation. It will be apparent that various modifications and changes can be made within the spirit and scope of the invention as described in the foregoing specification. Accordingly, the invention is therefore to be limited only by the scope of the appended claims.

What is claimed is:

1. A method of separating fiber and plastics in pre-engineered municipal solid waste, the method comprising the steps of:
providing a pre-engineered municipal solid waste stream;
shredding the pre-engineered municipal solid waste stream;
size-reducing the pre-engineered municipal solid waste stream in a primary hammer mill to a size that can pass through a ⅜″ screen;
size-reducing the pre-engineered municipal solid waste stream in a secondary hammer mill to a size that can pass through a ¼″ screen; and
pneumatically conveying the pre-engineered municipal solid waste to a separator whereby the pre-engineered municipal solid waste is separated into a medium weight material substantially comprising fibers and a light weight material substantially comprising plastics.
